(19) United States
(12) Patent Application Publication
(10) Pub. No.: US 2005/0034635 A1
(43) Pub. Date: Feb. 17, 2005

(54) Process and composition for the manufacture of cement expansion additive

(76) Inventors: Pin-Chuan Lin, Kaohsiung City (TW); Po-Liang Hsu, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/828,222

(22) Filed: Apr. 21, 2004

(30) Foreign Application Priority Data
Aug. 13, 2003 (TW) 09241518010

(51) Int. Cl. C04B 7/00

(52) U.S. Cl. 106/713; 106/739

(57) ABSTRACT

The present invention is related to the process and composition for the manufacture of cement expansion additive. The process comprises a blending step, a reaction step, and a calcination step. The blending step is to incorporate soluble calcium sulfate, soluble calcium oxide, and soluble aluminum compounds such as aluminum dross. The addition of water with the above incorporated materials to from ettringite is so-called reaction step. The calcination step is to calcine the products which are produced from reaction step at a temperature range between 60° C. and 900° C. by transforming ettringite from amorphous to calcium sulfoaluminate respectively. After calcinations, the final products can be used as expansive additives for cement or concrete. Further, this manufacturing method can effectively decrease raw material cost and production cost due to the raw material coming from recycling and no need to calcine at high temperature than other relative arts.

### BACKGROUND OF THE INVENTION

1. Field of the Invention

The present invention relates to the process and composition for the manufacture of cement expansion additive.

2. Description of the Related Art

In order to improve the shrinkage of concrete, it's a key method to gain expansion during the early hardening period after setting. Therefore, several kinds of expansive cement and expansive additives are developed to provide around the world. The expansive additive is to produce expansion to compensate the shrinkage of the original concrete and therefore to eliminate or to decrease the crack caused by drying shrinkage.

In 1965, Japan had not developed any expansive additive. At that time, both USA and U.K. relied on ettringite formation in cement paste to gain the expansion. Therefore, they developed and manufactured CSA type (calcium sulfoaluminate) and lime type expensive additive. These two countries are also the first two countries to use the expansive additive. Another type of expensive additive is to mix and grind clinker and gypsum by a certain proportion which is calcined individually.

Until now, there are many kinds of expansive additives for cement and concrete, such as CaO, MgO, C₄A₃\overline{S} (4CaO.3Al₂O₃.SO₃) and high aluminous cement. These expansive additives can be classified three types by the reactions: CaO reacting with H₂O becomes Ca(OH)₂, MgO reacting with H₂O becomes Mg(OH)₂, and C₄A₃\overline{S} reacting with gypsum and H₂O becomes ettringite. However, due to the unstable reaction of CaO type and MgO type, these two types are seldom used for the main ingredients of the expansive additive. Instead, C₃A.3CaSO₄.32H₂O (i.e. ettringite) is used as the expansive source at present and also in the future.

Therefore, in order to save cost without reducing the quality of products, some manufacturers develop a new manufacturing process, which is divided into raw material calcinations and mixing with gypsum. First, grind and mix raw materials, including limestone, gypsum and bauxite, and then calcine them in the rotary kiln at the temperature range between 1200° C. and 1400° C. to produce C₄A₃\overline{S} clinker. Finally, grind and mix this clinker and gypsum together and add adequate quick lime to form CSA expansive additive.

According to the above description, the mentioned method can provide an expansive additive. However, the three ingredients are all solid phases, and the three solid phases need to be calcined at high temperature in the rotary kiln in order that they can be synthesized and become a homogeneous phase. Therefore, the energy consumption during process causes high cost in the manufacture.

### SUMMARY OF THE INVENTION

In accordance with the present invention, the process and composition for the manufacture of cement expansion additive can reduce energy consumption during the process thereto save the cost.

According to this invention, the present invention comprises a blending step, a reaction step, and a calcination step. The blending step is to incorporate soluble calcium sulfate, soluble calcium oxide and soluble aluminum compounds. Mix the three materials together by a certain proportion. The addition of water with the above incorporated materials to form ettringite is so-called reaction step. Then, in the calcinations step, calcine the products which are produced from reaction step at a temperature range between 60° C. and 900° C. by transforming the ettringite from the amorphous to calcium sulfoaluminate respectively. After calcinations step, the final products can be used as expansive additives for cement or concrete. Further, this manufacturing method can effectively decrease material cost and production cost due to the raw material coming from recycling and no need to calcine at high temperature than other relative arts.

### BRIEF DESCRIPTION OF THE DRAWINGS

Other features and advantages of the present invention will be obvious in the following detailed description of the preferred embodiments of the present invention, with reference to the accompanying drawings, in which:

FIG. 1 is a preferred embodiment showing the manufacturing flow chart.

FIG. 2 is a x-ray diffraction testing chart presenting the relationship between the temperature and calcined mineral phases.

FIG. 3 is a testing chart presenting the expansion properties of each calcined condition.

### DETAILED DESCRIPTION OF THE PREFERRED EMBODIMENTS

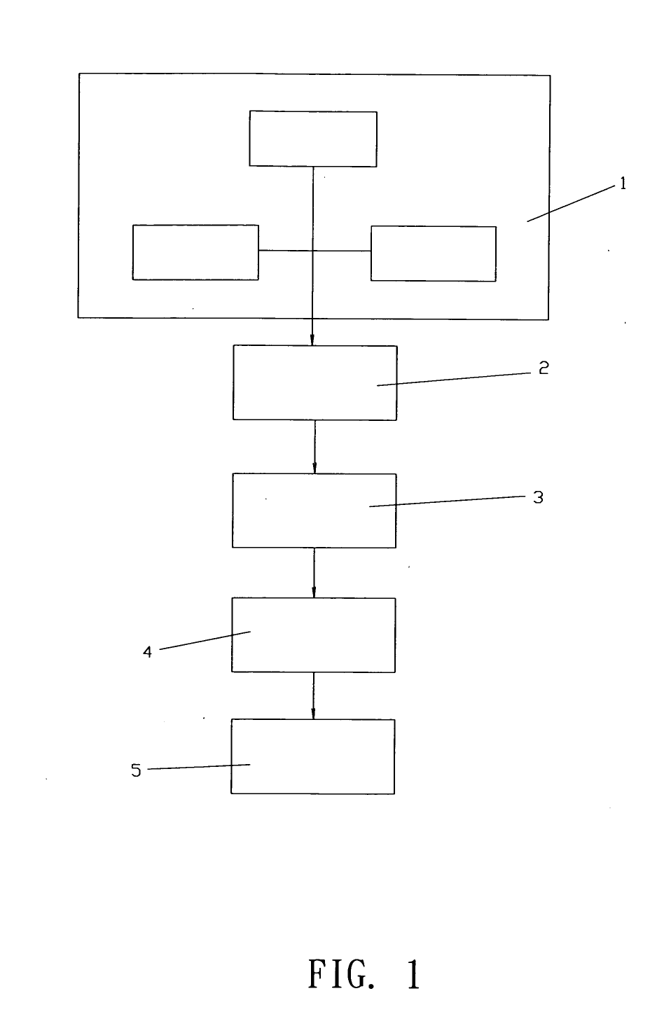

Referring to FIG. 1, it comprises the blending step 1, the reaction step 2, the degassing step 3, the dehydration step 4, and the calcination step 5.
(1) Blending step 1: it is to incorporate soluble calcium sulfate (i.e. CaSO₄), soluble calcium oxide (i.e. CaO), and soluble aluminum compounds (i.e. Aluminum dross). The
   1. soluble calcium oxide can be quick lime, hydrated lime. The preferred embodiment uses quick lime.
   2. soluble calcium sulfate can be gypsum, hemihydrate, anhydrite and Na₂SO₄.XH₂0. The preferred embodiment uses anhydrite.
   3. Soluble aluminum compounds can be aluminum dross or the waste which contains either mineral phase of AlN, Al(OH)₃, and aluminum fine powder. The preferred embodiment uses aluminum dross as the example.

Some substances of aluminum dross can dissolve in water into Al³⁺. That is why we call it soluble aluminum compound. The following shows the proportion of each mineral phase among aluminum dross.

| | |
|---|---|
| Al₂O₃ | 50% |
| MgAl₂O₄ | 20% |
| AlN | 15% |
| Al | 5% |
| Other impurities | 10% |

The above data of aluminum dross could be various with the different plants and different manufacture period. The above analysis is one of the preferred embodiments. More, the above example can be obtained from not only aluminum dross but also other industrial by-products when they contain soluble aluminum compounds. Further, aluminum dross in the preferred embodiment contains AlN and Al, so the NH3 and H2 are produced in the sequent manufactures. If the sample of the aluminum dross only contains Al(OH)₃, it also can be synthesized without any gas formation.

For example, aluminum dross uses α(g). The weight of the soluble aluminum compounds from the sample of aluminum dross is:

$$AlN = 0.15 α ( g ) , Al = 0.05 α ( g )$$

$$Therefore , \\ Convert 0.15 α ( g ) AlN = > \frac{0.15 α}{41} mole {Al}^{3 +}$$

$$0.15 α ( g ) Al = > \frac{0.05 α}{27} mole {Al}^{3 +}$$

$$So , the total {Al}^{3 +} is \text{:}$$

$$\frac{0.15 α}{41} + \frac{0.05 α}{27} = 0.00551 α$$

The molecular formula of the ettringite:
(CaO)₃.(Al₂O₃).(CaSO₄)₃.32H₂O

So, the mole ratio of CaO.Al₂O₃.CaSO₄:CaO:Al₂O₃:CaSO₄=3:1:3

Alternately, Ca²⁺:Al³⁺:SO₄²⁻=3:2:3

According to the above equations and the analysis of mole ratio, every 2 moles of Al³⁺ requires at least three moles of CaO and at least three moles of CaSO₄ for a complete reaction. Similarly, 2 moles Al³⁺ convert to 1 mole Al₂O₃. The following uses Al₂O₃ as the basic calculation, and the mole number of the Al³⁺ is 0.00551α. Alternately, when soluble Al₂O₃ is

$$( \frac{0.00551 α}{2} )$$

moles, the others to consume soluble Al₂O₃ completely require:

$$CaO ≧ 3 \times ( \frac{0.00551 α}{2} ) moles$$

$${CaSO}_{4} ≧ 3 \times ( \frac{0.00551 α}{2} ) moles$$

So, the above description shows:

$$( a ) CaO : at least 3 \times ( \frac{0.00551 α}{2} ) moles . \\ ( b ) {CaSO}_{4} : at least 3 \times ( \frac{0.00551 α}{2} ) moles . \\ ( c ) Aluminum dross : can obtain ( \frac{0.00551 α}{2} ) moles of soluble$$

Further, uniformly mix the above three mentioned solid phases together at room temperature, the weight ratio of the mixture is:

$$CaO : Aluminum dross : {CaSO}_{4} = ( 3 \times \frac{0.00551 α}{2} \times 56 ) : α : ( 3 \times \frac{0.00551 α}{2} \times 136 ) = 0.4629 : 1 : 1.1241$$

(2) Reaction step 2: the addition of water with the above mentioned materials is used to form ettringite. The reaction equations can be two as the followings:

Equation Expression:
2Al_{(S)}+3Ca(OH)_{2(S)}+3CaSO_{4(S)}+32H₂O₍ₗ₎→(CaO)₃.(Al₂O₃).(CaSO₄)₃.32H₂O_{(S)}+3H_{2(g)}↑ (1)
2AlN_{(S)}+3Ca(OH)_{2(S)}+3CaSO_{4(S)}+32H₂O₍ₗ₎→(CaO)₃.(Al₂O₃).(CaSO₄)₃.32H₂O_{(S)}+2NH_{3(g)}↑ (2)

Further, the obtained sample of aluminum dross contains AlN and Al, so the extra gas such as NH₃, H₂, are produced in the reaction step 2.
(3) Degassing step 3: According to above description in the reaction step 2, it shows the extra gas, such as NH₃ and H₂, are produced during the reaction process. Generally speaking, the evolution of the extra produced gas follows by mixing and disturbance into the air. It is, therefore, does not affect the quality of the expansive additive in sequent manufacture. Regarding the current regulations in Taiwan, the concentration of NH₃ should be under 50 PPM for the work environment. To be much well conformed to the regulations, no matter the extra gas exists or not, the preferred embodiment should further proceed to degas the extra gas for improving the safety of the work environment.
(4) Dehydration step 4: it dehydrates the extra free water produced in reaction step 2 for an easy sequent treatment.
(5) Calcination step 5: the above mentioned ettringite is calcined. The calcination temperature range is between 60° C. and 900° C. More, it transforms the ettringite from amorphous to calcium sulfoaluminate in order to generate the potential expansion property. After calcinations, the final products can be used as expansive additives for the cement or concrete.

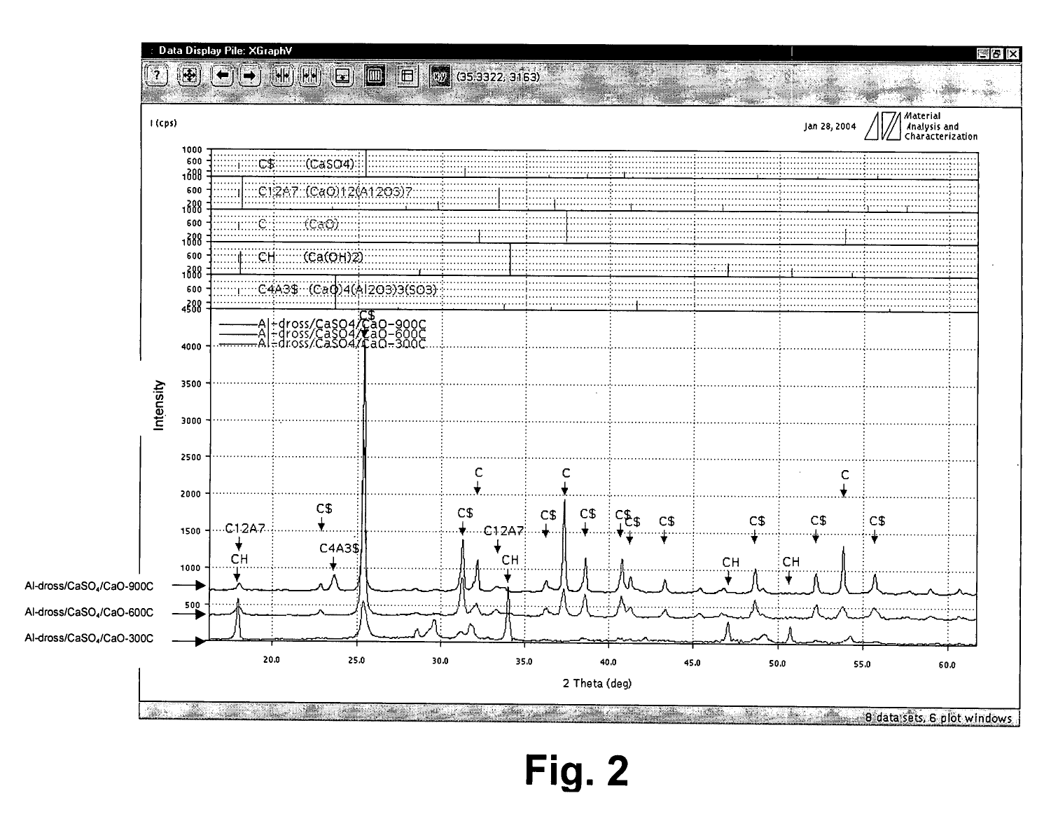

Referring to FIG. 1 and FIG. 2, if there is no extra gas formation in the other waste of the sample and no extra free water remained, it can directly proceed calcinations step 5 after processing the reaction step 2. However, the Aluminum dross in the present manufacture example contains extra gas produced. Therefore, the obtained ettringite still requires to go through the degassing step 3, the dehydration step 4 before starting the calcination step 5. The test, according to the ettringite calcination process from low temperature to high temperature, shows that the phase of the ettringite heated under 300° C. is decomposed crystalline water to form amorphous. If the calcination temperature goes up to reach at 600° C., it can be seen clearly that ettringite is decomposed as C₁₂A₇+C\overline{S}+C (C means CaO, A means Al₂O₃, \overline{S} means SO₃). While the calcination temperature goes up to reach at 900° C., ettringite is decomposed as C₄A₃\overline{S}+C₁₂A₇+C\overline{S}+C (C means CaO, A means Al₂O₃, \overline{S} means SO₃). All the phase transformations discussed above can all be used as expansive additive.

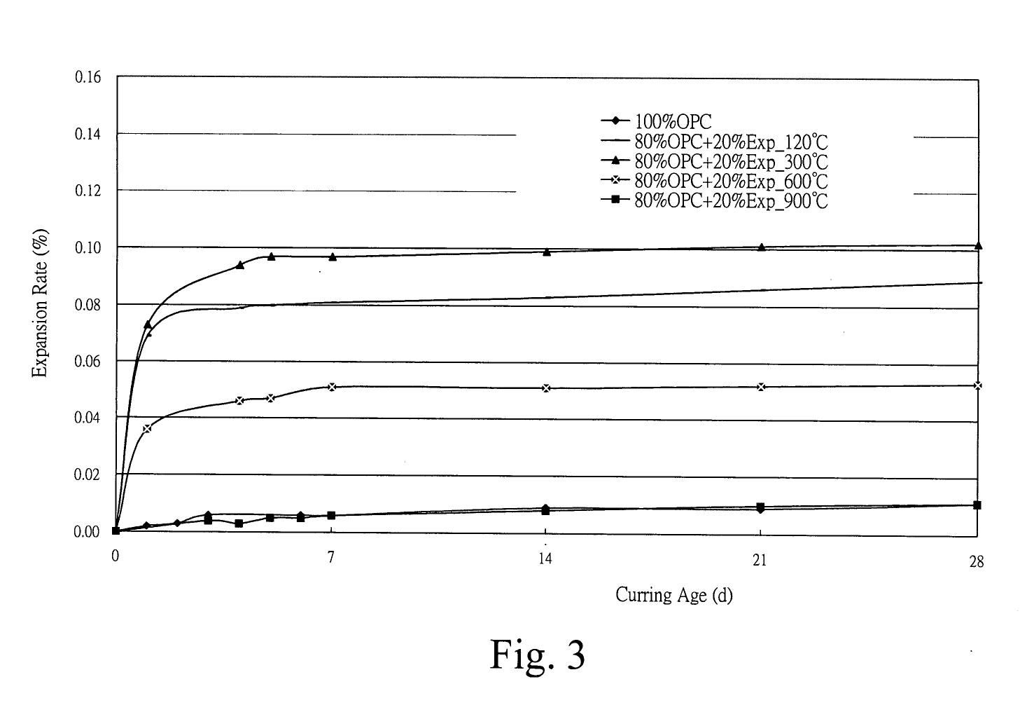

Referring to FIG. 3, the test is compliance with ASTM C806 based on an addition ratio of 20% expansive additive to substitute cement. At the range of calcinations temperatures from the room temperature to 900° C., they just show the expansive performances at 120° C., 300° C., 600° C., 900° C. It means that a better expansive result is not directly proportional to a higher temperature. From the above figures, they can present that the expansive addictives obtained in the calcinations temperature range between 60° C. and 900° C. are applicable to the cement or the concrete just because the more addition the more expansion.

According to the above description, the present invention incorporates aluminum compounds, soluble calcium oxide, and soluble calcium sulfate, and adds the water as the reaction medium. Then, it adequately uses a degassing step, a dehydration step, and a calcination step for forming a potentially expansive phase transformed from ettringite as an expansive additive, which is applicable to the cement or the concrete. Further, the manufacturing method can effectively decrease raw material cost and production cost, due to the raw material coming from recycling and no need to calcine at high temperature than other relative arts.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A composition for the manufacture of cement expansion additive comprises soluble calcium sulfate, soluble calcium oxide and soluble aluminum compounds which come from the waste recycling. The mixture mole ratio for the mixing recipe should be at least 3 moles CaO and at least 3 moles CaSO₄ when the soluble aluminum compounds possess 2 moles soluble Al³⁺.

2. A method for the manufacture of cement expansion additive comprises the steps in sequence as following
a). Blending step: incorporate soluble calcium sulfate, soluble calcium oxide, and soluble aluminum compounds and mix the above three materials together at room temperature;
b). Reacting step: add water after mixing the above material together uniformly as the medium for reacting to ettringite; and
c). Calcinations step: calcine the above ettrigite at the calcination temperature range between 60° C. and 900° C. to form an expansive additive for applying to the cement or the concrete by transforming the phase of ettringite.

3. The method according to claim 2, wherein the period between the reaction step and calcination step further comprises a degassing step, and it degases the extra gas which is formed from the process of the reaction step.

4. The method according to claim 3, wherein the period between the degassing step and calcination step further comprises a dehydration step. It dehydrates the extra free water which is the remainder from the process of the reaction step.

5. The composition according to claim 1, wherein the waste can contain either mineral phase of AlN, Al(OH)₃, and aluminum fine powder.

6. The composition according to claim 1, wherein the soluble calcium oxide can be quick lime or hydrated lime.

7. The composition according to claim 1, wherein the soluble calcium sulfate can be gypsum, hemihydrate, anhydrite and Na₂SO₄.XH₂O.

8. The method according to claim 2, wherein the transforming phase of ettringite in the calcination step mainly can be amorphous phase.

9. The method according to claim 2, wherein the transforming phase of ettringite in the calcination step mainly can be calcium aluminate or calcium sulfoaluminate.
